(19) United States
(12) Patent Application Publication
(10) Pub. No.: US 2003/0132924 A1
(43) Pub. Date: Jul. 17, 2003

(54) E-paper labels on recordable/removable media with optical data link and optical power supply

(76) Inventor: Robert S. Hamilton, Webster, NY (US)

Correspondence Address: OLIFF & BERRIDGE, PLC., P.O. BOX 19928, ALEXANDRIA, VA, 22320, US

(21) Appl. No.: 09/683,531

(22) Filed: Jan. 16, 2002

(51) Int. Cl. G09G 5/00

(52) U.S. Cl. 345/204

(57) ABSTRACT

A bistable addressable label which is usable with a recordable media to display certain characteristics of the recordable media, including the remaining storage space available. An electric paper label according to this invention is usable with recordable media to display certain characteristics of the recordable media or data stored therein; for example, detecting a write/read function, activating the label display, retrieving format and access authorization to contain fields within the label display, retrieving a serialization number and updating the serialization number, evaluating content transfer, evaluating remaining storage space, date stamping content transfers, evaluating content media and transfer reporting error determinations and displaying location of errors.

### BACKGROUND OF THE INVENTION

1. Field of Invention

The invention relates to electrically addressable labels for recording media, as well as methods of displaying images that are usable as labels.

2. Description of Related Art

Computer diskettes, video tape and other mediums are popularly used to store data. Users have found it convenient to label such mediums especially when the users have access to multiple mediums. In other words labels are attached to computer diskettes, video tapes, etc. to identify characteristics of the mediums, or to provide identifying or other information relevant to the data stored on the respective diskettes, video tapes, etc.

Paper or a similar product is a typical material used to create such conventional adhesive-backed labels. A paper-based product is thin, lightweight, portable, flexible, affordable, cost-efficient, high contrast, somewhat reusable, basically permanent, and can be easily configured into a multitude of shapes. In addition, paper is capable of maintaining the image without the need for a power source, such as, for example, batteries and other stored energy sources. In addition, paper can be read in ambient light, as well as marked upon with any number of implements, such as, for example, a pen, pencil, paintbrush, printers, photocopiers, and the like.

### SUMMARY OF THE INVENTION

However, although paper has many advantages as a display medium, paper is not well suited for electronically-addressable recording media. Conventional examples of electronically-addressable recording media cannot be displayed by means other than, for example, a cathode-ray tube (CRT) display or a liquid crystal display (LCD). Unfortunately, most electronically-addressable recording media lack many of the desirable advantages of paper, such as, for example, being lightweight, thin, portable, physically flexible, and the ability to retain a displayed image in a stable manner without a power source. As such, attempts have been made to combine the desirable qualities of paper with those of electronically-addressable recording media in order to provide an electrically addressable label for recording media that provides the advantages of both mediums. One such recording medium is electronic paper (or e-paper).

Like paper, electronic paper can be written on and erased, can be read in ambient light, and can retain information in the absence of an electric field or other external retaining force. Also, like ordinary paper, electric paper can be made in the form of a lightweight, flexible durable sheet. Yet, unlike paper, electric paper may be used to display imagery which changes over time. Thus, electric paper is adaptable for use in computer systems, television, signs and a host of other applications within the office, industrial and domestic settings.

A gyricon display, also referred to as a twisting-element display, a rotary element display, a particle display, or a dipolar particle light valve, is an example of technology for providing one type of electric paper. A gyricon display is an addressable display made up of a multiplicity of optically anisotropic particles, such as, for example, spheres, each of which can be selectively positioned to present a desired image to an observer. For example, a gyricon display can incorporate rotational elements each having two distinct halves, e.g., one half may be black, while the other half is white.

The rotational elements of the gyricon display are embedded in a sheet of optically transparent material that contains a multiplicity of cavities and is permeated by a transparent dielectric liquid. The fluid-filled cavities accommodate the rotational elements, with generally one element per cavity. Each element has a distinct electrical characteristic so that the elements are electrically as well as optically anisotropic. Thus, an element can be selectively positioned within its respective cavity by applying an electric field, to present either the black or the white half, for example, to the observer viewing the surface of the sheet.

An electric paper label according to this invention is usable with recordable media to display certain characteristics of the recordable media or data stored therein; for example, detecting a write/read function, activating the label display, retrieving format and access authorization to certain fields within the label display, retrieving a serialization number and updating the serialization number, evaluating content transfer, evaluating remaining storage space, date stamping content transfers, evaluating content media and transfer reporting error determinations and displaying location of errors.

### BRIEF DESCRIPTION OF THE DRAWINGS

The invention will be described in conjunction with the following drawings in which like reference numerals designate like elements and wherein:

FIG. 1 is a perspective, exploded view of a related art gyricon display;

FIG. 2 is a schematic diagram of a first exemplary embodiment of a label array according to the invention;

FIG. 3 is a schematic diagram of a second exemplary embodiment of a label array according to the invention;

FIG. 4 is a block diagram of a first exemplary embodiment of the display control system according to the invention;

FIG. 5 is a block diagram of a second exemplary embodiment of the display control system according to the invention;

FIG. 6 is a flowchart outlining a first exemplary embodiment of a method for controllably displaying an image on an e-paper media label according to the invention;

FIG. 7 is a flowchart outlining a second exemplary embodiment of a method for controllably displaying an image on an e-paper media label according to the invention;

FIG. 8 is a flowchart outlining a first exemplary embodiment of the evaluation of a content transfer according to the invention; and

FIG. 9 is a flowchart outlining a second exemplary embodiment of the evaluation of a content transfer according to the invention.

### DETAILED DESCRIPTION OF PREFERRED EMBODIMENTS

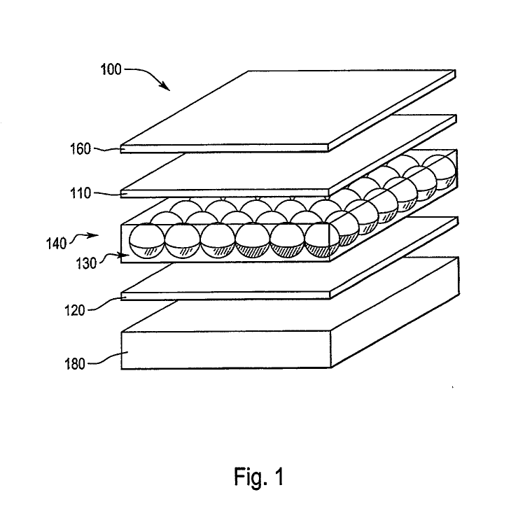

Related art gyricon displays can include various types of rotating particles or elements. For example, U.S. Pat. No. 4,126,854 to Sheridon, incorporated herein by reference in its entirety, depicts at FIGS. 1-3 an example of a twisting element panel display.

FIG. 1 shows an e-paper display device 100. As shown in FIG. 1, the e-paper display device 100 has a display panel 140 sandwiched between an upper substrate 160 and a lower substrate 180. Between the display panel 140 and the substrate 160 is a first-upper layer electrical conductor 110. The first-upper layer electrical conductor 110 may include a single continuous conductive layer, one or a plurality of patterned electrical conductors, or a matrix of selectively addressable electrical conductors, or the like. FIG. 1 also shows a second-lower layer electrical conductor 120 provided between the substrate 180 and the display panel 140. The second-lower layer electrical conductor 120 is similar to the first-upper layer electrical conductor 110, and may also comprise a single continuous conductive layer, or a plurality of patterned electrical conductors, or a matrix of selectively addressable electrical conductors, or the like.

At least one of the upper and lower substrates 160 and 180 and at least one of the layers of electrical conductors 110 or 120 are optically transparent so that the image displayable by the display device 100 can be viewed. In various exemplary embodiments, the upper substrate 160 and the upper layer of electrical conductors 110 are made of optically transparent material so that light incident upon the display layer 140 is reflected and/or absorbed to provide a visible image.

FIG. 1 also shows a gyricon layer 130 contained within the display panel 140. The gyricon layer 130 includes a distribution of minute particles which are optically anisotropic. These particles are surrounded by an optically transparent dielectric fluid. The particles have a difference in Zeta potential, which causes the particles to have an electrical anisotropy. In addition to the particles and the dielectric fluid which surrounds the particles, the gyricon includes a solid, optically transparent support material, which permits the particles to have the desired rotational freedom without having substantial translational freedom. This is described in greater detail in the incorporated '854 patent and in U.S. Pat. No. 4,143,103 to Sheridon, which discloses a method of making a display panel incorporated herein by reference in its entirety. As described in the “103 patent, the solid, optically transparent support material can be an elastomer or a rigid plastic, such as, for example polyethylene, polystyrene or Plexiglas.

In the gyricon layer 130, one half of each of the particles exhibits optical absorption characteristics, i.e., appears dark or black, and the other half of each of the particles exhibits light reflectance characteristics, i.e., appears light or white. The difference between the light reflectance-light absorption characteristics of halves provides the desired optical anisotropy.

Each of the particles is located within a cavity of the transparent support material. The cavities have a diameter slightly larger than the diameter of particles so that the particles have rotational freedom without translational freedom. The dielectric fluid fills the voids between the particles and the cavities. The dielectric fluid due the difference in Zeta potential between each of the halves, and the immersion of each of the particles and the dielectric fluid, the particles acquire an uneven electric charge, where one of the halves is more positive than the other half.

When an external power source is coupled across the upper and lower layers of electrical conductors 110 and 120 to apply an electric field across the solid, optically transparent support material, the positively charged halves of the particles will be attracted to the negative one of the upper and lower layers of electrical conductors 110 and 120, while the negatively charged halves of the particles will be attracted to the positive one of the upper and lower layers of electrical conductors 110 and 120. This operation is described in greater detail in the incorporated “854 and “103 patents.

In an alternative embodiment, the material used to form the solid, optically transparent support may be made from a very large number of dielectric materials that are attained by hardening a liquid phase of the material into which liquid filled shells containing the bichromal balls have been dispersed. In general, the shells permit chemical isolation of the hardenable material from the encapsulated liquid, providing great freedom in choosing the solid, optically transparent support material. U.S. Pat. No. 5,604,027 to Sheridon, incorporated herein by reference in its entirety, depicts two particular methods of microencapsulation.

As discussed above, one or both of the first-upper and second-lower layers of electrical conductors 110 and 120 may contain one or a plurality of patterned conductors. The first-upper and second-lower layers of electrical conductors 110 and 120 are positioned adjacent to the display panel 140 which contains the gyricon layer 130. The patterned electric conductors of the first-upper electrical conductors 110 are connected to a shared input source. The patterned electric conductors of the second-lower electrical conductors 120 are also connected to a shared input source, in a manner known in the art, so that pulsed electric fields can be applied to the respective patterned electric conductors of the first-upper and second-lower electrical conductors, respectively.

In operation, for example, a first pulsed electric field is applied to the regions of the display panel 140 comprising the patterned electric conductors of the first-upper electrical conductors 110, which a second pulsed electric field is synchronized with the first pulsed electric field and supplied simultaneously to the second-lower electrical conductors 120.

An electric field is the derivative of a voltage with respect to a distance, in the case of a parallel plate capacitor, E=V/d. Where E is equal to the electric field, V is equal to a voltage and d is equal to a distance. Therefore, a given electric field can be achieved with a lower applied voltage, by reducing the distance over which the voltage is applied. This is discussed in greater detail in U.S. Pat. No. 5,808,783 to Crowley which is incorporated in its entirety by reference.

As discussed in the “783 patent, and as shown in FIG. 1, an e-paper display 100 may be fabricated by a monolayer configuration of individual gyricon balls. Accordingly, for example, a monolayer configuration will minimize the distance over which a voltage must be applied and therefore require a relatively small operating voltage. Further, the patterned electric conductors of the first-upper and second-lower electrical conductors 110 and 120 are used to address adjacent pixels in an e-paper display layer 140 employing a monolayer of gyricon balls 130.

For clarity of explanation, the patterned electric conductors of the first-upper electrical conductors 110 are held at a positive voltage (V+) and the patterned electric conductors 120 are held at a negative voltage (V−), with respect to a common ground (not shown). Since the applied voltages are of opposite signs, the individual pixels addressed by patterned electric conductors of the first-upper and second-lower electrical conductors 110 and 120 are of opposite colors. For example, the monolayer gyricon layer 130 may be, comprised of a two-region bichromal ball. These two-region bichromal balls may be, for example, one-half white and the other half black. If each individual pixel addressed by the patterned electric conductors of the first-upper electrical conductor 110 are, for example, white, then each individual pixel addressed by the patterned electric conductors of the second-lower electrical conductor 120 would be, for example, black. However, this invention is not to be limited to a black and white bichromal-ball-typed display. The display layer 140 can use other color combinations, and may encompass any other known or later developed color schemes of a multiplicity of optically anisotropic particles, such as, for example, spheres, for use with display techniques or structure.

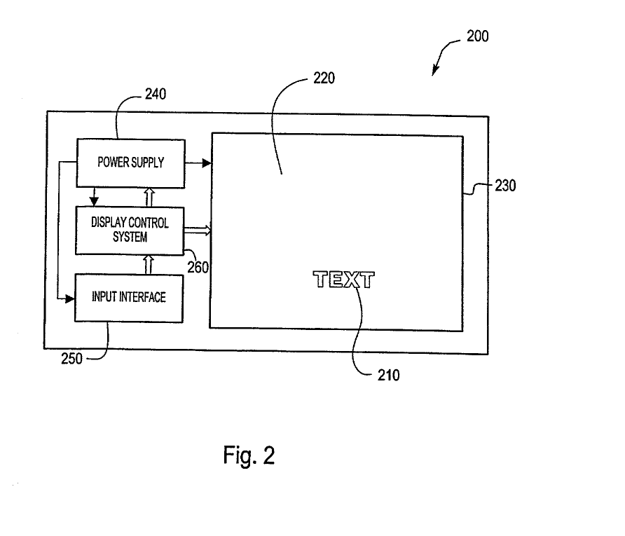

FIG. 2 illustrates a schematic view of an e-paper label 200 usable on a recordable medium in accordance with this invention. Accordingly, FIG. 2 illustrates the concept that if the first-upper electrical conductors 110 form the text 210, then the second-lower electrical conductor 120 forms the background 220. Furthermore, and for example, the background 220 may appear white, while the text 210 may appear dark, within a display portion 230 of the e-paper label 200. The power supply 240 may be, for example, a thin film battery, a photoelectric cell for ambient energy, electrical contact pads that are able to connect the e-paper label 200 to an externally supply power source, or any other conventionally known magnetic or mechanical coupling. Furthermore, the input interface device 250 may be implemented using any conventionally known or later developed input/output component, device or structure. For example, the input interface 250 can be a RS 232 type interface, an Universal Serial Bus (USB)—type interface, or the like. The input interface 250 can use optical or infrared coupling, electrical contact pads, magnetic or mechanical coupling or any other known or later developed connection technique and/or structure. Still further, the display portion 230 of the e-paper label 200 may include, for example, electric paper, and may display any conventional, particle-driven visible display characteristic. The particle display may, for example, be black and white, full color or operate in a highlight color in combination with a black and white. The e-paper label 200 is managed, for example, by the display control system 260.

It should be understood that if the polarity of the applied electric fields are reversed, light text on a dark background (not shown) will result, for example. Also, it should be understood that first and second electric fields can be applied asynchronously, such that the image can have the appearance of switching into or out of a background of the same shade, or synchronously such that the image and background switch simultaneously. In addition, it should be understood that either the background or the text can stay the same shade while the other changes shade. Such possibilities should be apparent to those in the art. It is also understood that the first-upper and second-lower electrical conductors 110 and 120 may contain a matrix of selectively addressable electrical conductors with which an image may be formed. An image containing text is only provided for explanation purposes. Any image can be displayed including text, symbols, shapes, addressable forms, etc., provided the display has sufficient resolution and the first-upper and second-lower electrical conductors 110 and 120 are properly formed and/or addressable.

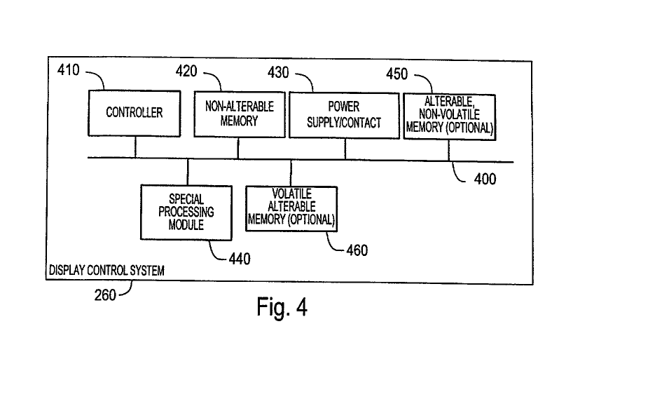

FIG. 4 is a block diagram of a first exemplary embodiment of the display control system according to the invention. The specialized microcontroller 260 which includes a controller 410, a memory 420 including a non-alterable memory array, a power supply or power contact 430, a special processing module 440, and optionally, an alterable non-volatile memory 450 and also optionally, a volatile alterable memory 460. The above components are coupled together through a signal bus 400. The microcontroller 260 may have, for example, an internal or external volatile alterable memory 460 to be used for temporary storage, since this storage may only be active during the underlying content write to, and copying functions of, for example, the computer diskette or video cassette. During periods other than the write to, or copying functions, the display control system 260 may, for example, shut down the volatile alterable memory 460 to conserve power.

The controller 410 controls the input/output of communication signals over the signal bus 400, and directs the special processing module 440 to perform special processing of the communication signals based upon the information contained in memory 420, including, for example, a non-alterable memory and similarly when the microcontroller 260 includes an alterable non-volatile memory 450, the controller 410 may direct the special processing module 440 to perform special processing of the communication signals based on the information retrieved from, for example, an alterable non-volatile memory 450.

The controller 410, for example, may also control access authorization to the special processing module 440, for example. The access authorization, may, for example, include an “encrypted key” or similar digital pass code, which if not detected by the controller 410, will prevent any communication processing. The presence of an encrypted key, or communication layer, is especially important for wireless devices which, when enabled, need to continually monitor their respective communication channel or networked base station. Additionally, with Blue Tooth™ wireless devices, for example, or similar locally enabled wireless devices, encryption or a digital pass code, may be used in combination with a addressable transmission distance.

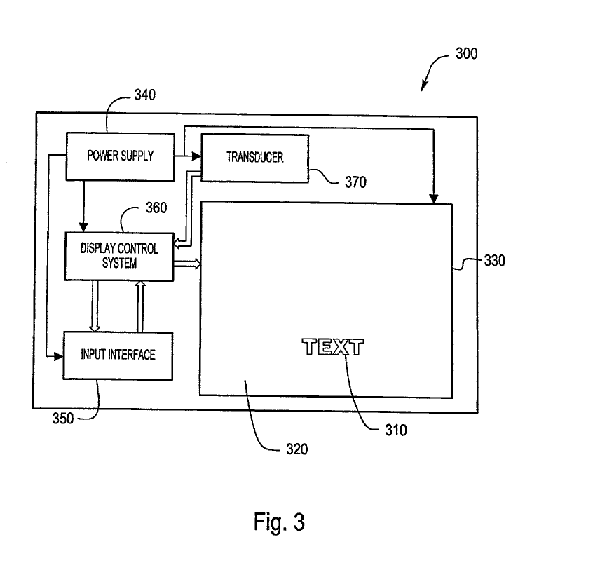

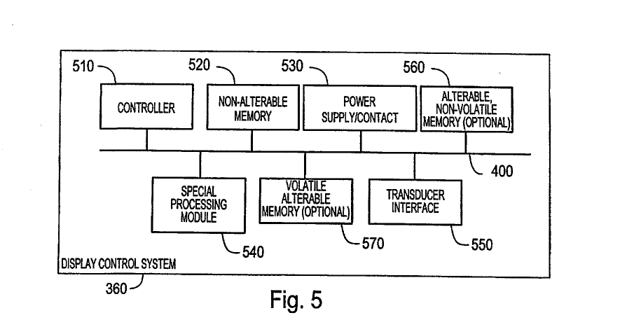

In another embodiment, as shown in FIG. 3, the schematic view of an e-paper label 300 usable on a recordable medium includes a transducer component. Further, FIG. 5, in accordance with the e-paper label of FIG. 3, is a block diagram of a second exemplary embodiment of the display control system 360 which includes a controller 510, a memory component including a non alterable memory 520, a power supply or contact point 530, a special processing module 540, a transducer 550, and optionally, an alterable non-volatile memory 560 and further optionally an additional volatile alterable memory 570. The above components are coupled together through a signal bus 500. The controller 510, for example, may also control access authorization to the special processing module 540, for example.

As discussed above, the access authorization, may, for example, include an “encrypted key” or similar digital pass code, which if not detected by the controller 510, will prevent any communication processing. The presence of an encrypted key, or communication layer, is especially important for wireless devices, for example, which, when enabled, need to continually monitor their respective communication channel or networked base station. Additionally, with Blue Tooth™ wireless devices, or similar locally enabled wireless devices, encryption or a digital pass code, may be used in combination with a addressable transmission distance.

The controller 510 controls the input/output of communication signals over the signal bus 500, and directs the special processing module 540 to perform special processing of the communication signals based on information contained in the memory 520 including, a non alterable memory and optionally, the information contained within the an alterable non-volatile memory 560, or the volatile alterable memory 570 as discussed below.

In a preferred embodiment of the invention, when a transducer 550 is present and detects, for example, changes in one or more of the following conditions, including temperature, light, humidity, acceleration, atmospheric pressure, motion, and/or the presence of, for example, carbon monoxide, propane, or any other mixture of hydrocarbon gases that occur with petroleum deposits, or the like. A detected shift in the monitored conditions will generate a communication signal sent by the transducer 550 to the special processing module 540 which will be recorded and/or displayed upon the label array in accordance with the particular label array format and corresponding first-upper and second-lower electrical conductors 110 and 120.

Additionally, another example application, including for example, a transducer, may be provided when an e-paper label is attached to a package for transport, or used in a shipping system for several packages, and package handling. In such systems or environments, an e-paper label could monitor changes in, for example, environmental conditions, and through various signage techniques, including, intermittent or constant color or highlighting changes, alert an individual or automated sensing device about certain environmental changes. Specifically, such environmental changes, may for example, include: temperature, light, humidity, or the like. Further, in systems where the materials are highly susceptible to changes in the environment, companies, or individuals, may better manage their handling procedures and minimize situations when the shipped items are damaged during delivery.

For simplicity of the following description of the invention, it will be assumed that the e-paper label 300 has been affixed to a computer disk which a user has inserted into a computer system and directed the computer system to write content to the computer diskette with the attached e-paper label 300. However, the invention is also intended to cover any recordable medium, whether presently known or later developed, which can be labeled with a particular e-paper label described herein.

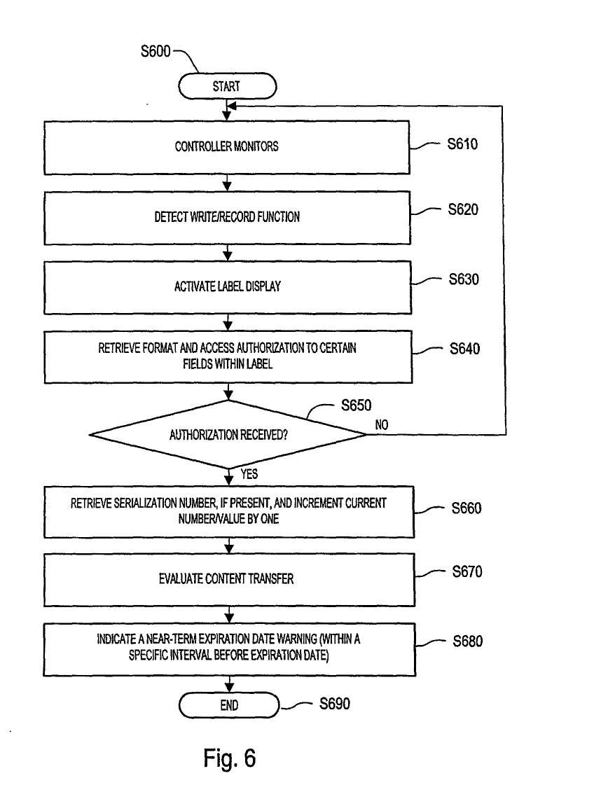

FIG. 6 is a flowchart outlining a first exemplary embodiment of a method for controlling displaying an image on an e-paper label according to the invention. As shown in FIG. 6, step S600 begins a first exemplary embodiment of a method for controlling displaying an image on an e-paper label. Step S600 may be initiated when, for example, the user inserts a recordable medium with an e-paper label, according to the invention, into a device configured for reading from and writing content to the recordable medium. Step S610 monitors the system, and when content has been written or recorded onto a diskette, for example, or any other recordable media at step S620, the e-paper label display 230 is activated at step S630. After the e-paper label display 230 has been activated at step S630, the system may, for example, retrieve format information and access authorization information pertaining to the particular fields, for example, within the e-paper label 200. If, at step S640, the user has not labeled the media with the label 200, the user, may be, for example, prompted to enter information relevant to the medium or date stored therein, such as an appropriate name or text to distinguish the media, which will appear upon the particular e-paper label 200, as, for example, text 210.

The system may confirm whether the user has received authorization at step S650, to access the e-paper label. If confirmation is not received, the system, may, for example, loop back to step S610 and repeats. If, however, the serialization process is initialized for the first time, the system, for example, may generate a display value of 1 or a similar first initialization indication. After completing step S650, and with authorization to access the e-label, the system proceeds to step S660 and retrieves the current serialization number or value, if present, and increments the current serialization number or value by 1. Alternatively, the user may elect to override the automatic serialization process, which may also include the automatic date stamp processing. After completing step 660, the system proceeds to step 670 and may, for example, evaluate a particular content transfer, as described in routine 670 below. After completing step 670, the system proceeds to step 680 and may, for example, record a near-term expiration date warning, if the content transfer is subject to an expiration date. Next, at step S690, the process ends.

The parameters contained in FIG. 6 and discussed herein, which include label format, label serialization number, expiration date, and near term expiration warning signals, for example, are merely provided for illustration. In fact, the e-paper label may include other parameters including known or later developed media formatting techniques. Furthermore, any formatting techniques may be changed or adapted as necessary, especially when this information is contained within an optional alterable non-volatile memory or similar device known or later developed.

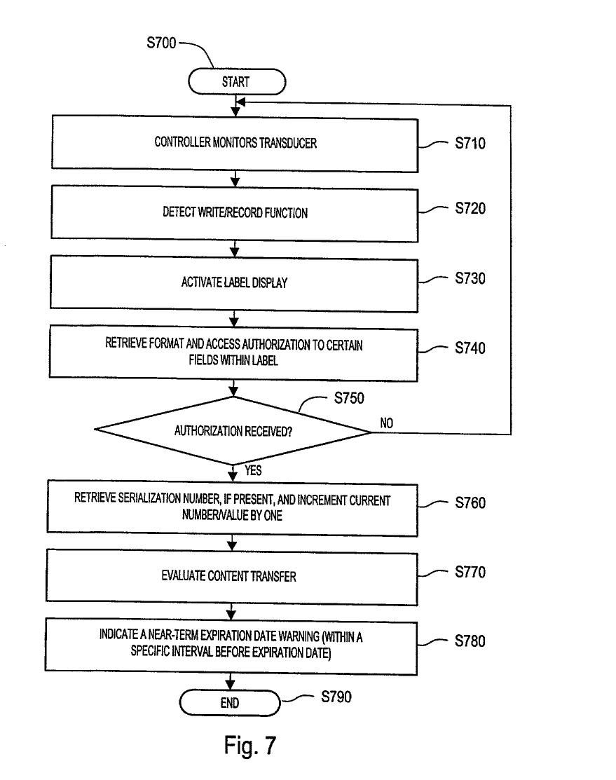

FIG. 7 is a flowchart outlining a second exemplary embodiment of a method for controlling displaying an image on an e-paper label according to the invention. As shown in FIG. 7, special processing may be provided according to the particular characteristics monitored by a particular transducer 550. As shown in FIG. 7, step S700 begins a second exemplary embodiment of a method for controlling displaying an image on an e-paper label. Step S700 may be initiated when, for example, the user inserts a recordable medium with an e-paper label, according to the invention, into a device configured for reading from and writing content to the recordable medium. Step S710 monitors the system, and when content has been written or recorded onto a diskette, for example, or any other recordable media at step S720, the e-paper label display 330 is activated at step S730. After the e-paper label display 330 has been activated at step S730, the system, may, for example, retrieve format information and access authorization information pertaining to the particular fields, or example, within the e-paper label 300. If at step S740, the user has not labeled the media with the e-paper level 300, the user, may be, for example, prompted to enter an appropriate name or text to distinguish the media which will appear upon the particular e-paper label 300, as, for example, text 310. The system may confirm whether the user has received authorization at step S750, to access the e-paper label. If confirmation is not received, the system, may, for example, loop back to step S710 and repeats. If, however, the serialization process is initialized for the first time, the system, for example, may generate a display value of 1 or a similar first initialization indication. After completing step S750, and with authorization to access the e-label, the system the system proceeds to step S760 and retrieves the current serialization number or value, if present, and increments the current serialization number or value by 1. Alternatively, the user may elect to override the automatic serialization process, which may also include the automatic date stamp processing. After completing S760, the system 510 proceeds to step S770 and may, for example, time and date stamp the particular content transfer, and may, for example, indicate an expiration date for content transfers of a less than infinite time duration. One such time-sensitive content transfer, may, include a demonstration version of a software program. After completing step S770, the system proceeds to step S780 and may, for example, record a near-term expiration date warning, if the content transfer is subject to an expiration date. Next, at step S790, the process ends.

The parameters contained in FIG. 7 as described herein, which include label format, label serialization number, expiration date, and near term expiration warning signals, are merely provided for illustration. In fact, the e-paper label may include other parameters including known or later developed media formatting techniques. Furthermore, any formatting techniques may be changed or adapted as necessary, when this information is contained within an optional alterable non-volatile memory or similar device known or later developed.

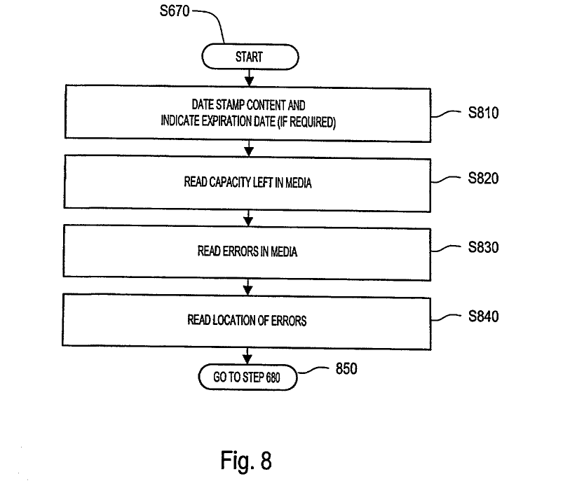

FIG. 8 is a flowchart outlining a first exemplary embodiment of the evaluation of a content transfer according to the invention. As shown in FIG. 8, the evaluation method begins at step S670, when the system proceeds from step S670 and evaluates a content transfer, the system, may, for example, time and date stamp the particular content transfer at step 810. In addition, at step S810, the system may indicate an expiration date for content transfers of a less than infinite time duration. One such example of a less than infinite, or otherwise time-sensitive content transfer, may, include a demonstration version of a particular software program. After completing step S810, the system proceeds to step S820, and may, for example, read the storage capacity remaining on a particular recordable medium. The system, may, for example, transfer this information to the e-paper label 200 display region 230. After completing step S820, the system proceeds to step S830, and may, for example, read the any errors found on a particular recordable medium. These errors may include, but are not limited to, format errors, write-to and read-from errors and include any other media preparation or content transfer created error either known or later discovered in data storage and transfer.

Additionally, after determining the existence of errors at step S830, the system, may, for example, proceed to step S840 and may, for example, read the location of any particular error detected in step S830. The controller 410, may, for example, transfer this information to the e-paper label 200 display region 230. The system at step S840, may, for example, determine the location of the particular error by a particular bit or byte-wise location, or generally by a sector-wise location. These error locations may include, but are not limited to, the above discussed memory locations and include any other storage location addressing method either known or later discovered in data storage and transfer. After completing step S840, at step S850 the system returns to step S680.

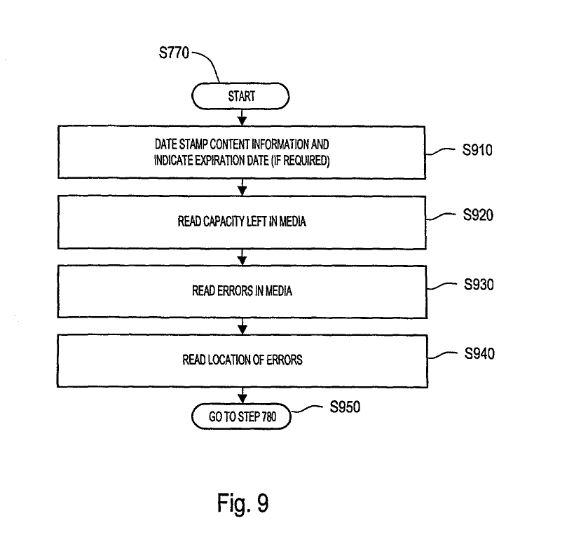

FIG. 9 is a flowchart outlining a second exemplary embodiment of the evaluation of a content transfer according to the invention. As shown in FIG. 9, the evaluation method begins at step S770, when the system proceeds from step S760 and evaluates a content transfer, the system, may, for example, time and date stamp the particular content transfer at step S910. In addition, at step S910, the system may indicate an expiration date for content transfers of a less than infinite time duration. One such example of a less than infinite, or otherwise time-sensitive content transfer, may, include a demonstration version of a particular software program. After completing step S910, the system proceeds to step S920, and may, for example, read the storage capacity remaining on a particular recordable medium. The system, may, for example, transfer this information to the e-paper label 300 display region 330. After completing step S920, the system proceeds to step S930, and may, for example, displaying any errors in response to any errors found when reading the status and/or errors, including their respective locations, on a particular recordable medium. These errors may include, but are not limited to, format errors, write-to and read-from errors, and include any other media preparation or content transfer created error either known or later discovered in data storage and transfer.

Additionally, after determining the existence of errors at step S930, the system, may, for example, proceed to step S940 and may, for example, read the location of any particular error detected in step S940. The system, may, for example, transfer this information to the e-paper label display 300 display region 330. The system at step S940, may, for example, determine the location of the particular error by a particular bit or byte-wise location. These error locations may include, but are not limited to, the above discussed memory locations and include any other storage location addressing method either known or later discovered in data storage and transfer. After completing step S940, at step S950 the system returns to step S780.

The above method of operation may be applied in any number of applications other than the applications specifically described above. The special processing may be dependent upon the particular application, including a particular transducer. Furthermore, many special processing sequences may be combined to provide greater versatility in the processing of information and displaying content upon the label array.

While this invention has been described with specific embodiments thereof, it is evident that many alternatives, modifications and variations will be apparent to those skilled in the art. Accordingly, the preferred embodiments of the invention as set forth herein are intended to be illustrative, not limiting. Various changes may be made without departing from the spirit and scope of the invention.

1. An addressable display useable as a label, comprising:
a bistable display device usable as a label;
an energy source that generates an operating signal; and
a microcontroller that receives the operating signal generated by the energy source and provides a control signal to the bistable display device so that an image is generated on the label.

2. The addressable display according to claim 1, wherein the bistable display comprises at least one of: a transducer, and an electric paper.

3. The addressable display according to claim 2, wherein the bistable display device comprises a gyricon display.

4. The addressable display according to claim 1, wherein the power source is at least one of: a thin film battery, and an ambient energy source.

5. The addressable display according to claim 4, wherein the ambient energy source converter is a photoelectric cell.

6. The addressable display according to claim 1, wherein the bistable display detects at least one of: a write-to function, and a read-from function.

7. The addressable display according to claim 1, wherein the bistable display retrieves at least one of: format and access authorization, and serialization information.

8. The addressable display according to claim 1, wherein the bistable display evaluates at least one of: content transfer, expiration date, capacity remaining in the media, errors in the media, and location of the errors in the media.

9. A user configurable bistable display useable as a label, comprising:
a bistable display device usable as a label;
a power source that generates an operating signal;
a controller that receives the operating signal and generates a control signal; and user configurable pattern electrodes affixed to a portion of the bistable display, the pattern electrodes receiving the control signal from the controller and applying an electric field across the user selected portions of the display device.

10. A method of displaying images usable as a label, comprising:
displaying a first image on a bistable display device usable as a label, the first image including a first region displayed with a first optical characteristic which is different than a second region displayed with a second optical characteristic;
receiving the display control signal produced by a circuit, the circuit be powered by a power source; and
responsively to the control signal, displaying a second image on the bistable display device, the second image including the first and second regions, the first region being displayed in a third optical characteristic other than the first optical characteristic and the second region being displayed in a fourth optical characteristic other than the second optical characteristic.

11. The addressable display according to claim 10, wherein the bistable display comprises at least one of: a transducer, and an electric paper.

12. The addressable display according to claim 11, wherein the bistable display device comprises a gyricon display.

13. The addressable display according to claim 10, wherein the power source is at least one of: a thin film battery, and an ambient energy source.

14. The addressable display according to claim 13, wherein the ambient energy source converter is a photoelectric cell.

15. The addressable display according to claim 10, wherein the bistable display detects at least one of: a write-to function, and a read-from function.

16. The addressable display according to claim 10, wherein the bistable display retrieves at least one of: format and access authorization, and serialization information.

17. The addressable display according to claim 10, wherein the bistable display evaluates at least one of: content transfer, expiration date, capacity remaining in the media, errors in the media, and location of the errors in the media.

18. A method of creating a display usable as a label, the method being suitable for execution proximate to a location where the display is to be deployed, the method comprising:
configuring a set of electrodes in a pattern corresponding to an image to be displayed as a label;
affixing the set of electrodes to a bistable, electrically activatable display device; and
operatively coupling the display device with the electrodes thus affixed to a power source and a controller, the controller being capable of generating a control signal for the display device using the power source.
